(19) United States
(12) Patent Application Publication
(10) Pub. No.: US 2013/0101486 A1
(43) Pub. Date: Apr. 25, 2013

(54) ON-LINE MONITORING AND CONTROLLING OF SULFUR COMPOUNDS IN POWER GENERATION FACILITIES FOR CARBON DIOXIDE CAPTURE PROCESSES AND ARTICLES COMPRISING THE SAME

(71) Applicants: Zheng Liu, Knoxville, TN (US); Naresh Handagama, Knoxville, TN (US); Barath Baburao, Knoxville, TN (US)

(72) Inventors: Zheng Liu, Knoxville, TN (US); Naresh Handagama, Knoxville, TN (US); Rasesh Kotdawala, Knoxville, TN (US); Barath Baburao, Knoxville, TN (US)

(73) Assignee: ALSTOM TECHNOLOGY LTD., Baden (CH)

(21) Appl. No.: 13/276,761

(22) Filed: Oct. 19, 2011

(51) Int. Cl. B01D 53/48; B01D 17/00; B01D 53/62

(52) U.S. Cl. 423/220; 423/242.1; 422/168; 210/96.1; 210/739

(57) ABSTRACT

An online monitoring and controlling system is used for monitoring and controlling sulfur content in heat stable salts or in a flue gas stream. The system comprises valves, sensors and analyzers that are operated by a valve flow and control system that regulates the valves to redirect flow of the heat stable salt or the flue gas stream to reduce the sulfur to below a desirable value. The valve and flow control system is automated and uses a feedback loop to control the sulfur content.

### TECHNICAL FIELD

This disclosure relates to on-line monitoring and controlling of sulfur compounds in power generation facilities and articles comprising the same. In particular, this disclosure relates to on-line monitoring and controlling sulfur compounds for heat stable salt management in the application of carbon dioxide capture from a mixed gas stream.

### BACKGROUND

Power generation systems generally combust hydrocarbon based fuels in order to generate energy. Such systems generally produce an end product that comprises primarily carbon dioxide and water (e.g., steam) as by-products of the energy generation process. In most cases, the stream will include varying amounts of nitrogen, oxygen, sulfur dioxide and other compounds.

Environmental pollution stemming from fossil-fueled power plants is of worldwide concern. Power plants emit air pollutants that may be toxic, e.g., toxic metals and polyaromatic hydrocarbons; precursors to acid rain, e.g., sulfur oxides (SOx) such as sulfur dioxide (SO₂), and nitrogen oxides (NOx); precursors to ozone such as NO₂ and reactive organic gases; particulate matter; and greenhouse gases, notably CO₂. Power plants also discharge potentially harmful effluents into surface and ground water, and generate considerable amounts of solid wastes, some of which may be hazardous.

Although technologies are being developed that reduce emissions and effluents, they are often expensive and require considerable energy. Technologies have been developed and are installed on most new power plants that significantly reduce emissions of NOₓ, SO₂ and particulates. However, CO₂ remains the one emission that is currently not controlled.

Several technologies can be employed to remove CO₂ from flue gases. These technologies include post combustion chemical scrubbing (such as amine scrubbing) and oxygen fired combustion. All of these technologies add capital cost to the plant and increase the cost of plant operation. For example, current solvent based (ammonia, amine-based, amino acid salts, ionic liquids, and the like) carbon dioxide capture systems (CCS) technologies from mixed gas streams uses 20 to 30% of the power generated by the power plant which reduces the available electrical output. In addition to this operating cost, the solvent management cost is also significant.

In coal fired boiler flue gas, the sulfur compounds are present in a very low concentration in comparison to the amount of moisture, carbon dioxide and nitrogen. Sulfur compounds present in the flue gases are removed in significant amounts via contact unit operations such as spray towers that utilize lime slurry, wet flue gas desulfurization, dry alkaline powder and dry flue gas desulfurization. However, even after these processes there is still a small amount of sulfur present in the flue gas. The presence of sulfur compounds even in small quantities creates problems for carbon capture systems. In order to continue to remove carbon dioxide from flue gases while minimizing disruptions in the carbon capture system, it is desirable to even further reduce the amount of sulfur compounds present in the flue gases.

### SUMMARY

Disclosed herein is an online monitoring system for controlling sulfur content in a flue gas stream comprising a first valve and a second valve disposed along the flue gas stream; the flue gas stream emanating from a power generation facility and discharging to a carbon capture system; the carbon capture system being operative to remove carbon dioxide from the flue gas stream; a sulfur scrubber that is effective to remove sulfur from the flue gas stream; the sulfur scrubber being disposed downstream of the first valve and upstream of the second valve and being in fluid communication with both the first valve and the second valve; the flue gas stream being split into a bypass stream and a stream that flows through the sulfur scrubber; the bypass stream being operative to bypass the sulfur scrubber and discharge its contents to the carbon capture system via the second valve; the stream that flows through the sulfur scrubber being operative to discharge its contents to the carbon capture system via the second valve; a first sensor disposed upstream of the first valve and upstream of the sulfur scrubber; the first sensor being in communication with a first analyzer; a second sensor disposed downstream of the sulfur scrubber and upstream of the second valve; the second sensor being in communication with a second analyzer; and a valve flow control system being in communication with the first valve, the second valve, the first sensor, the second sensor, the first analyzer and the second analyzer; the valve flow control system being operative to control the flow of the flue gas stream to the bypass stream and/or to the stream that flows through the sulfur scrubber.

Disclosed herein too is a method for controlling sulfur content in a flue gas stream comprising discharging the flue gas stream from a power plant to an online monitoring system; the online monitoring system comprising a first valve and a second valve disposed along the flue gas stream; the flue gas stream emanating from a power generation facility and discharging to a carbon capture system; the carbon capture system being operative to remove carbon dioxide from the flue gas stream; a sulfur scrubber that is effective to remove sulfur from the flue gas stream; the sulfur scrubber being disposed downstream of the first valve and upstream of the second valve and being in fluid communication with both the first valve and the second valve; the flue gas stream being split into a bypass stream and a stream that flows through the sulfur scrubber; the bypass stream being operative to bypass the sulfur scrubber and discharge its contents to the carbon capture system via the second valve; the stream that flows through the sulfur scrubber being operative to discharge its contents to the carbon capture system via the second valve; a first sensor disposed upstream of the first valve and upstream of the sulfur scrubber; the first sensor being in communication with a first analyzer; a second sensor disposed downstream of the sulfur scrubber and upstream of the second valve; the second sensor being in communication with a second analyzer; and a valve flow control system being in communication with the first valve, the second valve, the first sensor, the second sensor, the first analyzer and the second analyzer; the valve flow control system being operative to control the flow of the flue gas to the bypass stream and/or to the stream that flows through the sulfur scrubber; measuring the sulfur content of the flue gas stream in the first sensor and the first analyzer; discharging the flue gas stream to a carbon capture system via the bypass stream if sulfur content is below 20 parts per million; the parts per million being measured in volume of the flue gas stream; or splitting the flue gas stream into two streams, the bypass stream and the stream that flows through the scrubber; when the sulfur content is greater than 20 parts per million; reducing the sulfur content in the stream that flows through the scrubber; measuring the sulfur content at the second sensor; discharging the flue gas stream to the carbon capture system when the sulfur content as measured by the second sensor is less than or equal to about 20 parts per million; or discharging the entire flue gas stream to the scrubber if the sulfur content in the stream that flows through the scrubber is less than or equal to about 20 parts per million as measured by the second sensor.

Disclosed herein too is an online monitoring system for controlling sulfur content in heat stable salts comprising a third valve and a fourth valve disposed along a liquid stream; the liquid stream emanating from a regenerator and discharging to an absorber carbon capture system; the absorber being operative to remove carbon dioxide from a flue gas stream; a reclaimer that is effective to remove sulfur from the liquid stream; the reclaimer being disposed downstream of the third valve and upstream of the fourth valve and being in fluid communication with both the third valve and the fourth valve; the liquid stream being split into a bypass stream and a stream that flows through the reclaimer; the bypass stream being operative to bypass the reclaimer and discharge its contents to the absorber via the fourth valve; the stream that flows through the reclaimer being operative to discharge its contents to the absorber via the fourth valve; a third sensor disposed upstream of the third valve and upstream of the reclaimer; the third sensor being in communication with a third analyzer; a fourth sensor disposed downstream of the reclaimer and upstream of the fourth valve; the fourth sensor being in communication with a fourth analyzer; and a valve flow control system being in communication with the third valve, the fourth valve, the third sensor, the fourth sensor, the third analyzer and the fourth analyzer; the valve flow control system being operative to control the flow of the liquid stream to the bypass stream and/or to the stream that flows through the reclaimer.

Disclosed herein too is a method for controlling sulfur content in a liquid stream comprising discharging the liquid stream from a regenerator to an online monitoring system; the online monitoring system comprising a third valve and a fourth valve disposed along a liquid stream; the liquid stream emanating from a regenerator and discharging to an absorber carbon capture system; the absorber being operative to remove carbon dioxide from a flue gas stream; a reclaimer that is effective to remove sulfur from the liquid stream; the reclaimer being disposed downstream of the third valve and upstream of the fourth valve and being in fluid communication with both the third valve and the fourth valve; the liquid stream being split into a bypass stream and a stream that flows through the reclaimer; the bypass stream being operative to bypass the reclaimer and discharge its contents to the absorber via the fourth valve; the stream that flows through the reclaimer being operative to discharge its contents to the absorber via the fourth valve; a third sensor disposed upstream of the third valve and upstream of the reclaimer; the third sensor being in communication with a third analyzer; a fourth sensor disposed downstream of the reclaimer and upstream of the fourth valve; the fourth sensor being in communication with a fourth analyzer; and a valve flow control system being in communication with the third valve, the fourth valve, the third sensor, the fourth sensor, the third analyzer and the fourth analyzer; the valve flow control system being operative to control the flow of the liquid stream to the bypass stream and/or to the stream that flows through the reclaimer; measuring the sulfur content of the liquid stream in the third sensor and the third analyzer; discharging the liquid stream to an absorber via the bypass stream if a sulfur content is below 3 weight percent; based on a total weight of the liquid stream; the sulfur content being determined by an amount of heat stable salts in sulfate and sulfide form present in the liquid stream; or splitting the liquid stream into two streams, the bypass stream and the stream that flows through the reclaimer; when the sulfur content is greater than 3 weight percent; reducing the sulfur content in the stream that flows through the reclaimer; measuring the sulfur content at the third sensor; discharging the liquid stream to the absorber when the sulfur content as measured by the fourth sensor is less than or equal to about 3 weight percent in the liquid stream; or discharging the entire liquid stream to the reclaimer if the sulfur content in the stream that flows through the reclaimer is greater than or equal to about 3 weight percent based on the weight of the liquid stream.

### BRIEF DESCRIPTION OF THE FIGURES

FIG. 1 depicts an on-line monitoring and controlling system for controlling the amount of sulfur compounds in a flue gas stream;

FIG. 2 is a flow control routine that is implemented by the valve and flow control system for controlling the amount of sulfur compounds in a flue gas stream;

FIG. 3 is an on-line monitoring and controlling system for heat-stable salt management; and

FIG. 4 is a depiction of a control routine implemented by the valve and flow control system.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Disclosed herein is an on-line monitoring and controlling system for controlling the amount of sulfur compounds in a flue gas stream. It is generally desirable to minimize and manage the heat-stable salt arising from sulfur contained in a flue gas stream. Sulfur salts can degrade the chemistry occurring in an absorber where carbon dioxide is removed from the flue gas stream using amine based solvents.

The on-line monitoring and controlling system may also be adapted to provide heat-stable salt management during carbon dioxide capture from a mixed gas stream. In one embodiment, the on-line monitoring and controlling system comprises a sulfur scrubber disposed between two sensors a first sensor and a second sensor. The sulfur scrubber is also disposed between the two valves—a first valve and a second valve. A valve and flow control system (VFCS) communicates with each of the sensors and valves to determine whether the flue gas stream should be scrubbed in the scrubber or bypass the scrubber and be transported to the carbon capture system.

In another embodiment, a heat stable salt management system comprises a solvent reclaimer disposed between absorber and regenerator towers. Like the sulfur scrubber in the foregoing embodiment, the solvent reclaimer is disposed between two valves—a third valve and a fourth valve. The solvent reclaimer is also disposed between two sensors—a third sensor and a fourth sensor. The valve and flow control system communicates with each of the sensors and the valves to determine whether the flue gas stream should be subjected to solvent reclamation in the solvent reclaimer of bypass the solvent reclaimer and be transported to the regenerator tower.

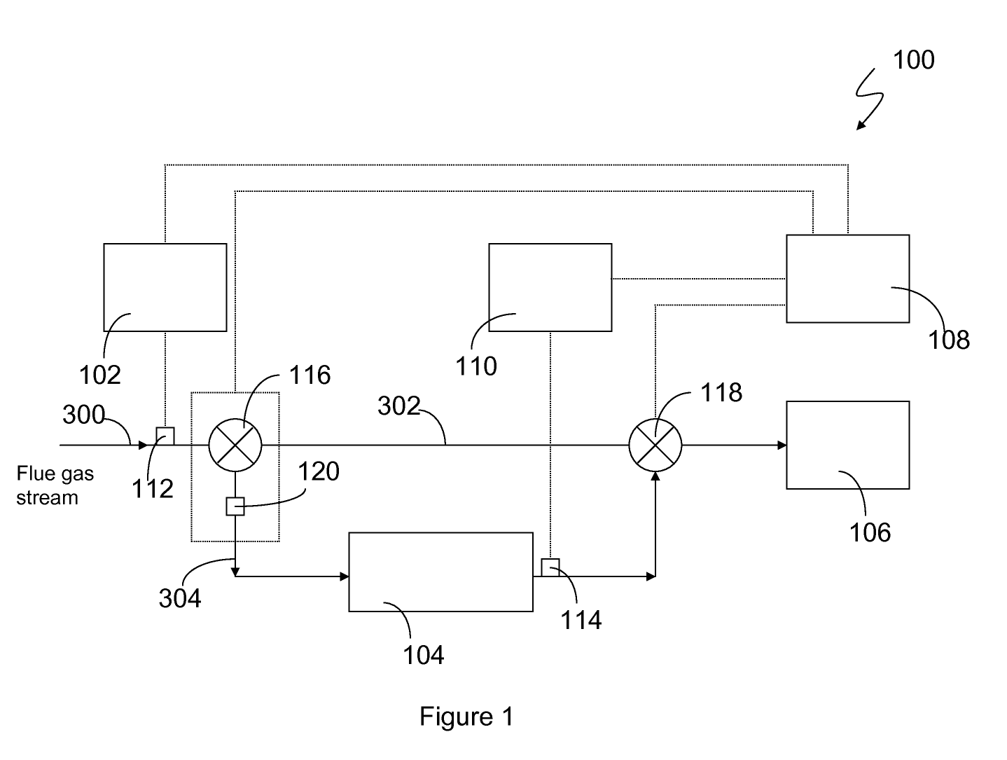

FIG. 1 depicts an on-line monitoring and controlling system 100 for controlling the amount of sulfur compounds in a flue gas stream. The system 100 comprises a first sensor 112, a second sensor 114, a first analyzer 102 in communication with the first sensor 112, a second analyzer 110 in communication with the second sensor 114, a first valve 116, a second valve 118, a sulfur scrubber 104, and a valve and flow control system 108 in communication with the first analyzer 102 and the second analyzer 110. The system 100 is in fluid communication with a carbon capture system 106.

The flue gas stream 300 is transported to the carbon capture system 106 either directly along a stream 302 (also called the bypass stream or the first stream) or along a stream 304 (a second stream) which contains the scrubber 104 and flows through the scrubber 104. The first sensor 112 and the second sensor 114 are disposed along the path of travel of the flue gas stream 300. The scrubber 104 is disposed between the first sensor 112 and the second sensor 114. The first sensor 112 lies upstream of the scrubber 104, while the second sensor 114 lies down stream of the scrubber 104. The first sensor 112 is in operative communication with the first analyzer 102 while the second sensor 114 is in operative communication with the second analyzer 110. In one embodiment, the first sensor 112 is in electrical communication with the first analyzer 102 while the second sensor 114 is in electrical communication with the second analyzer 110.

The first valve 116 lies upstream of the scrubber 104 at the point where the bypass stream 302 separates from the stream 304 that flows through the scrubber. The first valve 116 and the second valve 118 are in fluid communication with the scrubber 104. The second valve 118 lies downstream of the scrubber 104 at the point where the first flue gas stream 302 meets the second flue gas stream 304. The first valve 116 is in fluid communication with a flow controller 120.

The sensor and the analyzer unit may be a single unit or may comprise multiple units that are in communication with one another and are further in communication with the valve and flow control system 108. The sensor and analyzer units may comprise a sample pump, an ash filter, heating sampling lines, an oxygen scrubber, or the like, or a combination thereof The sensors and the analyzers may be equipped with a heating unit to ensure it to achieve optimal sensitivity to sulfur. The analyzer can comprise a near-infrared laser sulfur analyzer, an automatic color based sulfur analyzer, or the like, or a combination thereof. The analyzers chosen for use in the control and monitoring system will depend on the specific flue gas into CCS system. Analytical instruments such as conductivity meters, automatic titrators, automatic colorimeters, automatic ion chromatographs and ion specific electrodes can also be included in the present on-line monitoring and controlling system.

The valve and flow control system 108 uses the output signals of the various sensors and analyzers to detect sulfur contents in the flue gas stream at the locations detailed in the FIG. 1. The valve and flow control system 108 also communicates with the valves to regulate the amount of gas stream transported to the scrubber. The valve and flow control system 108 is in communication with a data acquisition system (not shown) that can read and record data instantaneously. The data acquisition system feeds information back to the system 100 so that the results from analysis conducted on the flue gas stream can be used to control and tune sulfur contents in the flue gas stream prior to its entry into the carbon capture system 106.

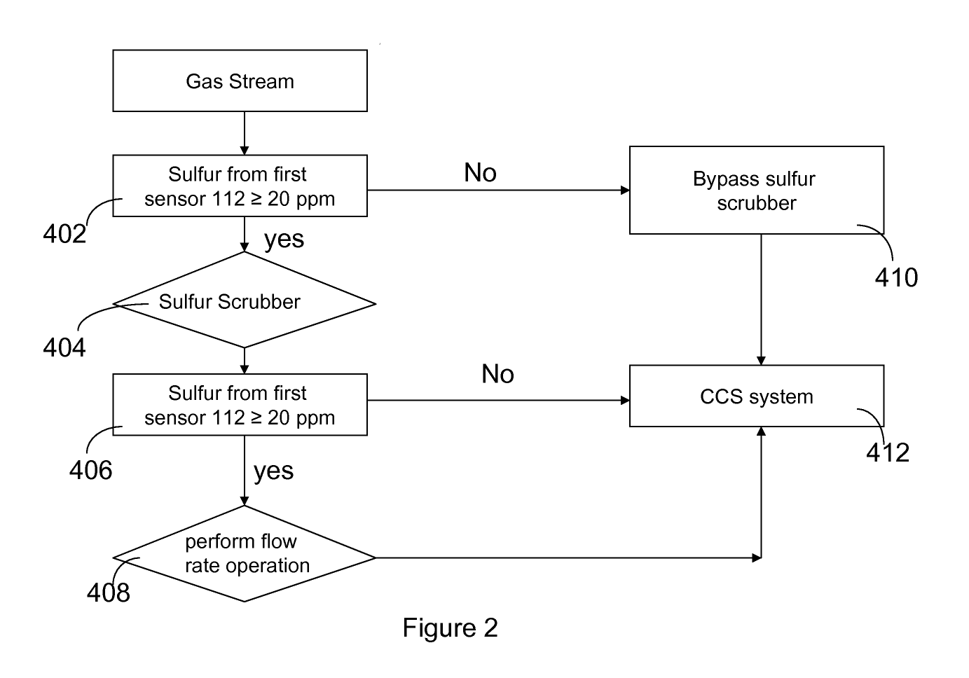

The method of operating of the system 100 of the FIG. 1, is detailed below with reference to the FIG. 2. The FIG. 2 is a flow control routine that is implemented by the valve and flow control system 108. The FIG. 2 comprises a series of process items listed as 402 through 412.

The FIG. 2 that shows that if the flue gas stream as measured by the first sensor 112 (see process item 402) contains less than, for example, 20 parts per million of sulfur, then the flue gas stream is transported directly to the carbon capture system 106 bypassing the scrubber 104 as can be seen in process item 410. This process item is detailed further immediately below.

With reference now once again to the FIG. 1, the flue gas stream 300 from a power plant is transported towards the carbon capture system 106 where carbon dioxide is removed from the flue gas stream prior to sequestration. The flue gas stream is detected by the first sensor 112 and its contents are analyzed by the first analyzer 102. If the sulfur content (as analyzed by the first analyzer 102) in the flue gas stream is below the a desired level (e.g., 20 parts per million), the valve and flow control system 108 directs the first valve 116 and the second valve 118 to open in a manner that is effective to direct the flue gas stream along the stream path 302 towards the carbon capture system 106.

If on the other hand, as has been described above, the flue gas stream contains more than, for example, 20 parts per million of sulfur (see process item 402 in the FIG. 2), then the flue gas stream is split into two parts, with a first part being directly charged to the carbon capture system along stream 302 while the second part is directed to the scrubber (see process item 404) along stream 304. The flow in the split stream is regulated by the first valve 116 and the second valve 118 and the flow controller 120. The ratio of flow along the stream 302 and the stream 304 is regulated by the first valve 116 and the second valve 118 to reduce the sulfur content in the recombined stream prior to entry into the carbon capture system to less than the desired amount.

Sulfur from the stream 304 is removed by the scrubber 104. The scrubber removes sulfur by reacting it with ammonia to form sulfates. If the sulfur content in the stream is reduced to below the 20 parts per million, specifically less than 10 parts per million, and more specifically less than 5 parts per million, as determined by the second sensor 114, then the first stream and the second stream are recombined at the second valve 118 and the combined stream is directed to the carbon capture system 106 (see process item 412 in the FIG. 2) for carbon dioxide removal.

If after leaving the scrubber, the sulfur content in the flue gas is still greater than, for example, 20 parts per million, as determined by the second sensor 114, then the valve and flow control system 108 directs the entire stream of the flue gas to be passed through the scrubber to perform a flow rate operation (see process item 408 in the FIG. 2) to remove the sulfur from the flue gas stream till the sulfur content is at the desired level. When the sulfur content as measured by the second sensor 114 is less than, for example, 20 parts per million, then the flue gas is directed to the carbon control system 106 (see process item 412).

In one embodiment, it is desirable for the system 100 to reduce the amount of sulfur in the flue gas stream to less than or equal to about 20 parts per million, specifically to less than or equal to about 10 parts per million, and more specifically to less than or equal to about 5 parts per million, prior to its entry into the carbon capture system 106.

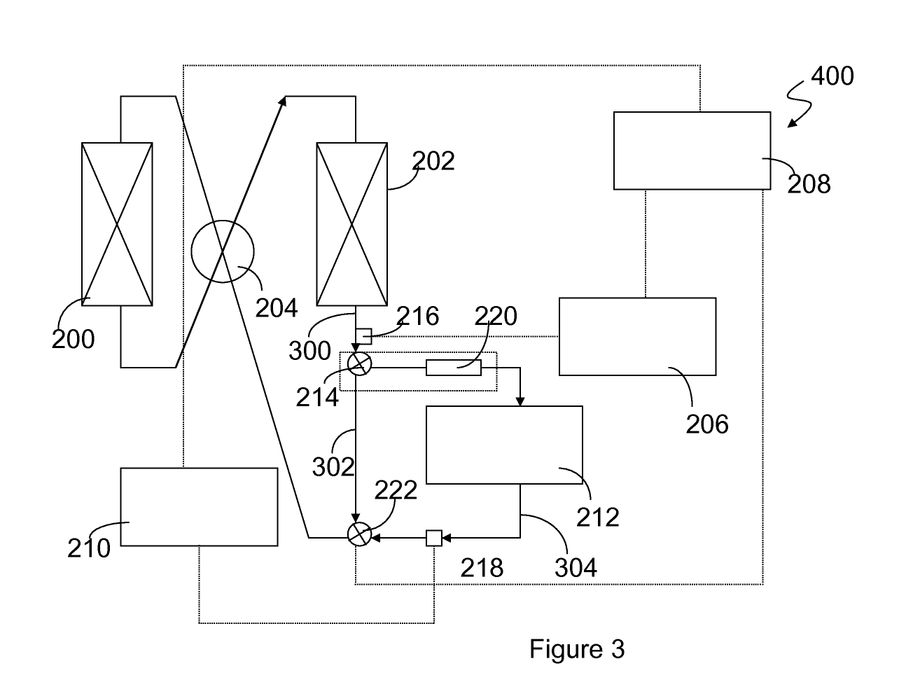

As noted above, the system 100 can also be adapted to facilitate heat-stable salt management during carbon dioxide capture from a mixed gas stream. With reference now to the FIG. 3, an on-line monitoring and controlling system 400 for heat-stable salt management comprises an absorber 200 in fluid communication with a regenerator 202 via a heat exchanger 204. The system further comprises a third valve 214, a fourth valve 222, a third sensor 216, a fourth sensor 218, a third analyzer 206 in operative communication with the third sensor 216, a fourth analyzer 210 in operative communication with the fourth sensor 218, and a solvent reclaimer 212 (hereinafter reclaimer 212) integrated downstream of the absorber 202 and upstream of the regenerator 200. The reclaimer 212 is used to reclaim the heat stable salt.

The third valve 214 is in electrical communication with a flow control sensor 220. In one embodiment, the third analyzer 206 is in electrical communication with the third sensor 216, while the fourth analyzer 210 is in electrical communication with the fourth sensor 218.

The third sensor 216, the third analyzer 206, the fourth sensor 218 and the fourth analyzer 210 are in electrical communication with a valve and flow control system 208. A feedback loop from the valve and flow control system 208 to the third valve 214 directs the third valve 214 to direct a liquid stream 300 to the reclaimer 212 via stream 304 or to direct it to the absorber 200 via a bypass stream 302. The third valve 214 and the third sensor 216 lie upstream of the reclaimer 212, while the fourth valve 222 and the fourth sensor 218 lie downstream of the reclaimer 212. The third valve 214 lies at the point at which a by pass stream 302 separates from the stream 304 that charges the liquid to the reclaimer 212. The fourth valve 222 lies at the point where the two streams 302 and 304 may be recombined if desired. The third sensor 216 lies upstream of the third valve 214 along the liquid stream 300 from the regenerator 202.

The feedback directions from the valve and flow control system 208 to the third valve 214 are dependent upon the sulfur content in the liquid stream emanating from the regenerator 202. The third sensor 216 and the fourth sensor 218 are mounted on the liquid stream and provide information about the flow rate and the sulfur content to the third and the fourth analyzers 206 and 210 respectfully. Such analyzer/sensor systems can include real time ionic chromatography devices, an automatic pH meter and titrator, or the like, or a combination thereof. These may include devices that can extract samples from the liquid stream for analyses.

The analyzers selected for use in the on-line monitoring and controlling system 400 will depend on the specific chemical composition of the flue gas that enter the on-line monitoring and controlling system 400. Analytical instruments such as conductivity meters, automatic titrators, automatic calorimeters, automatic ion chromatographs and ion specific electrodes can be included in the on-line monitoring and controlling system 400.

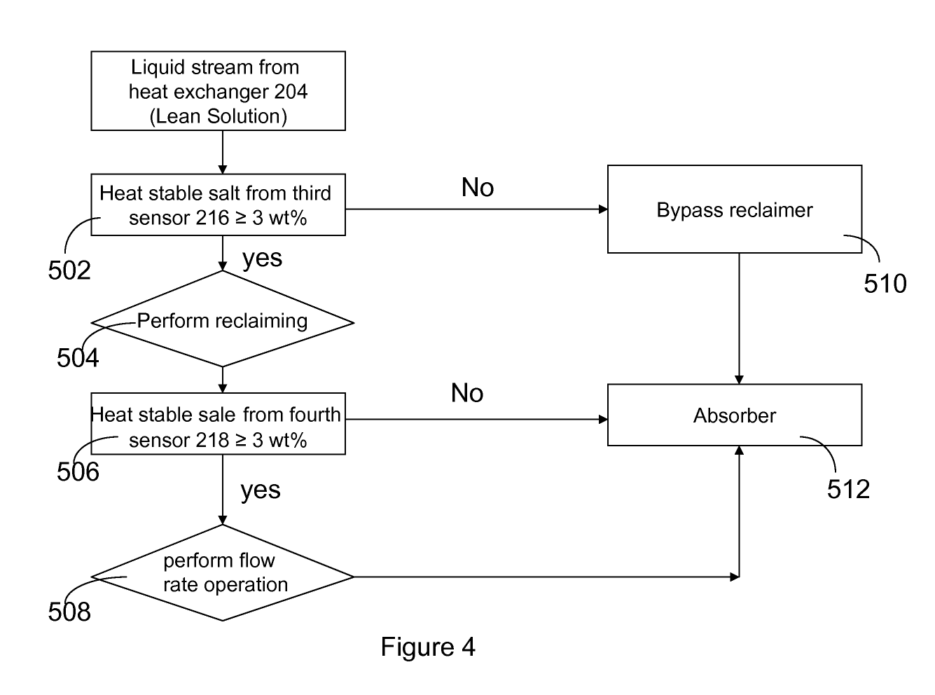

With reference now to the FIG. 3, a liquid stream 300 emanating from the regenerator 202 via liquid stream 300 bypasses the reclaimer 212 via bypass stream 302 if the sulfur content (as measured by the presence of sulfides/sulfates) is less than a desired amount (e.g., 200 parts per million) or alternatively via stream 304 (partially or completely) into the reclaimer 212 followed by being charged into the absorber 200. The determination of whether the stream is charged directly to the absorber 200 via the bypass stream 302 or to the reclaimer 212 via stream 304 depends on the sulfur content of the lean solution emanating from the regenerator 202. This is discussed in greater detail below with reference to the FIGS. 3 and 4.

As can be seen in the FIG. 3, a liquid stream 300 (emanating from the regenerator 202) containing an amine salt is split into two streams—a bypass stream 302 and a stream 304 that passes through the reclaimer 212 to reduce the sulfur content of the stream. The liquid stream is charged to the absorber 200 only if the sulfur content is below a desired level (e.g., 3 weight percent based on the total weight of the liquid stream). The sulfur content being determined by an amount of heat stable salts in sulfate and sulfide form present in the liquid stream. In one embodiment, the liquid stream comprises amines and hence the sulfur content is determined by the amount of heat stable salts in sulfate and sulfide form present in the amines.

Flue gas from a power plant is introduced into an absorber 200, where it reacts with an amine solvent or with ammonia to form an amine salt or an ammonia salt (e.g., ammonia bicarbonate/ammonia carbonate). The amine salt or ammonia salt is then charged to the regenerator 202 via the rich-lean heat exchanger 204. In the regenerator 202, the amine salt is decomposed to yield carbon dioxide and the amine solvent. If ammonia is used to extract the sulfate salts, then the ammonia sulfate salts will decompose in the regenerator 202 to yield ammonia and the corresponding sulfate salt, which is removed, leaving behind the ammonia. The amine solvent is then charged back to the absorber 200, where it contacts additional flue gas to remove additional carbon dioxide. The cycle is repeated thus continually removing carbon dioxide from the flue gas stream. However as noted above, the presence of excess sulfur in the flue gas stream degrades the amine solvent. It is therefore desirable to remove excess sulfur present in the form of sulfates and/or sulfides from the flue gas stream prior to entering the absorber 200.

The operation of the system 400 in the FIG. 3 will now be detailed with reference to the control routine implemented by the valve and flow control system depicted in FIG. 4. The FIG. 4 is a depiction of a control routine implemented by the valve and flow control system 208 and comprises the process items 502 through 512. A liquid stream 300 from the regenerator 202 is directed towards the reclaimer 212. The reclaimer 212 can be an appendix column, an exchange unit, an electrodialysis unit, a regenerator column, or a combination comprising at least any one of the foregoing.

The liquid stream is analyzed by the third sensor 216 for its sulfur content (see process item 502 in the FIG. 4). If the sulfur content (based on sulfides and sulfate content) is below a certain desired amount (for example 20 ppm as seen in the FIG. 4), the liquid stream is charged directly to the absorber 200 along bypass stream 302 (see process item 510). If on the other hand, if the sulfur content is greater than the desired amount, the liquid stream is split with a portion being directed to the bypass stream 302 and the remainder being directed to the reclaimer 212 along the stream 304. The ratio of the liquid stream directed to the bypass stream 302 to the stream 304 is dependent upon the amount of sulfur in the liquid stream 300. The valve and flow control system 208 regulates the third valve 214 and the fourth valve 222 to split the liquid stream 300 in amounts such that the stream 304 after being subjected to reclamation reduces the amount of sulfur in the heat stable salt to less than the desired amount, whereupon the stream is directed to absorber 202 (see process items 506 and 512). The sulfur content (in the form of sulfates and/or sulfides) of the stream 304 is determined by the fourth sensor 218.

If the sulfur content of the combined stream (downstream of the valve 222) is still greater than the desired amount, then the valve flow control system 208 performs a flow rate operation (see process item 508) on the liquid stream emanating from the regenerator 202, whereby the entire stream 300 is subjected to reclamation in the reclaimer 212 till the amount of sulfur in the stream (as determined by the fourth sensor 218 is less than the desired amount). When the sulfur content is less than the desired amount, the liquid stream is discharged to the absorber 200.

The reclaimer 212 may use either an amine solvent of ammonia in order to remove the heat stable salts present in the liquid stream. In one embodiment, if ammonia is used in the reclaimer 212, then it is desirable to discharge the liquid stream to the reclaimer 212 if it contains an amount of greater than 2000 parts per million of heat stable salts. If it contains less than 2000 parts per million of the heat stable salts, then it will bypass the reclaimer 212. The reclaimer 212 takes in only about 0.1 to about 10 wt % of the amine solvent stream.

If an amine solvent is used in the reclaimer, it is desirable to discharge the liquid stream directly to the absorber 200 bypassing the reclaimer 212, when the sulfur content (the content of heat stable salts) as measured by the third sensor is less than 3 wt %, specifically less than 2 wt %, and more specifically less than 1 wt %, based on the total weight of the liquid stream. If the sulfur content is greater than 3 wt %, then the liquid stream is discharged to the reclaimer 212.

The aforementioned systems are advantageous in that it provides means for automatic control systems to control sulfur content that is admitted into a carbon capture control system and also permits a lower concentration of sulfur in the heat-stable salts in the carbon capture system.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. An online monitoring system for controlling sulfur content in a flue gas stream comprising:
a first valve and a second valve disposed along the flue gas stream; the flue gas stream emanating from a power generation facility and discharging to a carbon capture system; the carbon capture system being operative to remove carbon dioxide from the flue gas stream;
a sulfur scrubber that is effective to remove sulfur from the flue gas stream; the sulfur scrubber being disposed downstream of the first valve and upstream of the second valve and being in fluid communication with both the first valve and the second valve;
the flue gas stream being split into a bypass stream and a stream that flows through the sulfur scrubber; the bypass stream being operative to bypass the sulfur scrubber and discharge its contents to the carbon capture system via the second valve; the stream that flows through the sulfur scrubber being operative to discharge its contents to the carbon capture system via the second valve;
a first sensor disposed upstream of the first valve and upstream of the sulfur scrubber; the first sensor being in communication with a first analyzer;
a second sensor disposed downstream of the sulfur scrubber and upstream of the second valve; the second sensor being in communication with a second analyzer; and
a valve flow control system being in communication with the first valve, the second valve, the first sensor, the second sensor, the first analyzer and the second analyzer; the valve flow control system being operative to control the flow of the flue gas stream to the bypass stream and/or to the stream that flows through the sulfur scrubber.

2. The online monitoring system of claim 1, further comprising a flow control valve that is disposed downstream of the first valve and upstream of the sulfur scrubber.

3. The online monitoring system of claim 1, where the valve flow control system is operative to regulate the first valve and the second valve so as to regulate the amount of the flue gas that is discharged through the bypass stream and the amount of flue gas that flows through the sulfur scrubber.

4. The online monitoring system of claim 1, where the first sensor and the first analyzer, and the second sensor and the second analyzer are operative to detect sulfur content in the flue gas stream.

5. The online monitoring system of claim 1, where the first sensor and the second sensor are selected from the group consisting of a sample pump, an ash filter, an oxygen scrubber, or a combination thereof.

6. The online monitoring system of claim 1, where the first sensor and/or the second sensor are equipped with a heating unit.

7. The online monitoring system of claim 1, where the first sensor and/or the second sensor are selected from the group consisting of a near-infrared laser sulfur analyzer, an automatic color based sulfur analyzer, or a combination thereof.

8. A method for controlling sulfur content in a flue gas stream comprising:
discharging the flue gas stream from a power plant to an online monitoring system; the online monitoring system comprising:
a first valve and a second valve disposed along the flue gas stream; the flue gas stream emanating from a power generation facility and discharging to a carbon capture system; the carbon capture system being operative to remove carbon dioxide from the flue gas stream;
a sulfur scrubber that is effective to remove sulfur from the flue gas stream; the sulfur scrubber being disposed downstream of the first valve and upstream of the second valve and being in fluid communication with both the first valve and the second valve; the flue gas stream being split into a bypass stream and a stream that flows through the sulfur scrubber; the bypass stream being operative to bypass the sulfur scrubber and discharge its contents to the carbon capture system via the second valve; the stream that flows through the sulfur scrubber being operative to discharge its contents to the carbon capture system via the second valve;
a first sensor disposed upstream of the first valve and upstream of the sulfur scrubber; the first sensor being in communication with a first analyzer;
a second sensor disposed downstream of the sulfur scrubber and upstream of the second valve; the second sensor being in communication with a second analyzer; and
a valve flow control system being in communication with the first valve, the second valve, the first sensor, the second sensor, the first analyzer and the second analyzer; the valve flow control system being operative to control the flow of the flue gas to the bypass stream and/or to the stream that flows through the sulfur scrubber;
measuring the sulfur content of the flue gas stream in the first sensor and the first analyzer;
discharging the flue gas stream to a carbon capture system via the bypass stream if the sulfur content is below 20 parts per million; the parts per million being measured in volume of the flue gas stream; or
splitting the flue gas stream into two streams, the bypass stream and the stream that flows through the scrubber; when the sulfur content is greater than 20 parts per million;
reducing the sulfur content in the stream that flows through the scrubber;
measuring the sulfur content at the second sensor;
discharging the flue gas stream to the carbon capture system when the sulfur content as measured by the second sensor is less than or equal to about 20 parts per million; or
discharging the entire flue gas stream to the scrubber if the sulfur content in the stream that flows through the scrubber is less than or equal to about 20 parts per million as measured by the second sensor.

9. The method of claim 8, further comprising removing carbon dioxide from the flue gas stream; the removing of the carbon dioxide being conducted in the carbon capture system.

10. The method of claim 8, where the valve and flow control system regulates the amount of flue gas in the bypass stream and the stream that flows through the scrubber by regulating the first valve and the second valve.

11. The method of claim 10, where the valve and flow control system regulates the first valve and the second valve based on information received from the first analyzer and the second analyzer.

12. An online monitoring system for controlling sulfur content in heat stable salts comprising:
a third valve and a fourth valve disposed along a liquid stream; the liquid stream emanating from a regenerator and discharging to an absorber carbon capture system; the absorber being operative to remove carbon dioxide from a flue gas stream;
a reclaimer that is effective to remove sulfur from the liquid stream; the reclaimer being disposed downstream of the third valve and upstream of the fourth valve and being in fluid communication with both the third valve and the fourth valve; the liquid stream being split into a bypass stream and a stream that flows through the reclaimer; the bypass stream being operative to bypass the reclaimer and discharge its contents to the absorber via the fourth valve; the stream that flows through the reclaimer being operative to discharge its contents to the absorber via the fourth valve;
a third sensor disposed upstream of the third valve and upstream of the reclaimer; the third sensor being in communication with a third analyzer;
a fourth sensor disposed downstream of the reclaimer and upstream of the fourth valve; the fourth sensor being in communication with a fourth analyzer; and
a valve flow control system being in communication with the third valve, the fourth valve, the third sensor, the fourth sensor, the third analyzer and the fourth analyzer; the valve flow control system being operative to control the flow of the liquid stream to the bypass stream and/or to the stream that flows through the reclaimer.

13. The online monitoring system of claim 12, further comprising a flow control valve that is disposed downstream of the third valve and upstream of the reclaimer.

14. The online monitoring system of claim 12, where the valve flow control system is operative to regulate the third valve and the fourth valve so as to regulate the amount of the liquid stream that is discharged through the bypass stream and/or the amount of the liquid stream that flows through the reclaimer.

15. The online monitoring system of claim 12, where the third sensor and the third analyzer, and the fourth sensor and the fourth analyzer are operative to detect sulfur content in the liquid stream.

16. The online monitoring system of claim 12, where the third sensor and the fourth sensor are selected from the group consisting of a sample pump, an ash filter, an oxygen scrubber, or a combination thereof.

17. The online monitoring system of claim 12, where the third sensor and/or the fourth sensor are equipped with a heating unit.

18. The online monitoring system of claim 12, where the third analyzer and/or the fourth analyzer are selected from the group consisting of automatic ionic chromatography devices, an automatic pH meter, a titrator, conductivity meters, automatic titrators, automatic calorimeters, ion specific electrodes or a combination thereof.

19. A method for controlling sulfur content in a liquid stream comprising:
discharging the liquid stream from a regenerator to an online monitoring system; the online monitoring system comprising:
a third valve and a fourth valve disposed along a liquid stream; the liquid stream emanating from a regenerator and discharging to an absorber carbon capture system; the absorber being operative to remove carbon dioxide from a flue gas stream;
a reclaimer that is effective to remove sulfur from the liquid stream; the reclaimer being disposed downstream of the third valve and upstream of the fourth valve and being in fluid communication with both the third valve and the fourth valve; the liquid stream being split into a bypass stream and a stream that flows through the reclaimer; the bypass stream being operative to bypass the reclaimer and discharge its contents to the absorber via the fourth valve; the stream that flows through the reclaimer being operative to discharge its contents to the absorber via the fourth valve;
a third sensor disposed upstream of the third valve and upstream of the reclaimer; the third sensor being in communication with a third analyzer;
a fourth sensor disposed downstream of the reclaimer and upstream of the fourth valve; the fourth sensor being in communication with a fourth analyzer; and
a valve flow control system being in communication with the third valve, the fourth valve, the third sensor, the fourth sensor, the third analyzer and the fourth analyzer; the valve flow control system being operative to control the flow of the liquid stream to the bypass stream and/or to the stream that flows through the reclaimer;
measuring the sulfur content of the liquid stream in the third sensor and the third analyzer;
discharging the liquid stream to an absorber via the bypass stream if a sulfur content is below 3 weight percent; based on a total weight of the liquid stream; the sulfur content being determined by an amount of heat stable salts in sulfate and sulfide form present in the liquid stream; or
splitting the liquid stream into two streams, the bypass stream and the stream that flows through the reclaimer; when the sulfur content is greater than 3 weight percent;
reducing the sulfur content in the stream that flows through the reclaimer;
measuring the sulfur content at the third sensor;
discharging the liquid stream to the absorber when the sulfur content as measured by the fourth sensor is less than or equal to about 3 weight percent in the liquid stream; or
discharging the entire liquid stream to the reclaimer if the sulfur content in the stream that flows through the reclaimer is greater than or equal to about 3 weight percent based on the weight of the liquid stream.

20. The method of claim 19, further comprising removing carbon dioxide from the liquid stream; the removing of the carbon dioxide being conducted in the absorber.

21. The method of claim 19, where the valve and flow control system regulates the amount of flue gas in the bypass stream and the stream that flows through the scrubber by regulating the third valve and the fourth valve.

22. The method of claim 19, where the valve and flow control system regulates the third valve and the fourth valve based on information received from the third analyzer and the fourth analyzer.

24. The method of claim 19, where the liquid stream comprises amines.
